(19) United States
(12) Patent Application Publication
(10) Pub. No.: US 2019/0281872 A1
(43) Pub. Date: Sep. 19, 2019

(54) Method of Plant Resin Separation and Extraction

(71) Applicant: Tetragrow LLC, Calistoga, CA (US)

(72) Inventor: David M. Cilia, Calistoga, CA (US)

(21) Appl. No.: 16/423,071

(22) Filed: May 27, 2019

Related U.S. Application Data
(63) Continuation-in-part of application No. 15/640,111, filed on Jun. 30, 2017, now Pat. No. 10,300,494.
Application No. 15/640,111 is a continuation-in-part of application No. 14/634,794, filed on Feb. 28, 2015, now Pat. No. 9,718,065.
(60) Provisional application No. 61/946,536, filed on Feb. 28, 2014.

(51) Int. Cl. A23L 27/10; C12C 3/00; C12C 5/02; C12G 3/06; A23L 2/56

(52) U.S. Cl. CPC A23L 27/11; C12C 3/00; A23V 2002/00; C12G 3/06; A23L 2/56; C12C 5/02

(57) ABSTRACT

Trichomes are removed from hops flowers and the related undesirable vegetative matter by a process that deploys water slurry agitation to produce a mixture of solid trichomes and similarly sized plant debris from the flowers. The plant debris are then removed by gravity filtration in a dense inert liquid, which is preferably a salt or brine solution. The desirable trichomes or trichome glands float on the dense liquid, while the undesirable vegetative matter sinks to the bottom of the brine containing vessel. The trichomes are readily removed and can be processed further to form concentrates for flavoring beer or other beverage, as well as added directly to beer at any stage in the brewing process.

### CROSS REFERENCE TO RELATED APPLICATIONS

The present application is a Continuation-in-part of and claims the benefit of priority to the US Non-Provisional patent application of the same title having application Ser. No. 15/640,111 that was filed on 30 Jun. 2017, which in turn is a Continuation-in-part of and claims the benefit of priority to the US Non-Provisional patent application of the same title having application Ser. No. 14/634,794 that was filed on 28 Feb. 2015, and issued as U.S. Pat. No. 9,718,065 on 21 Aug. 2017, all of which are incorporated herein by reference.

The present application also claims the benefit of priority to the US Provisional patent application of the same title having application Ser. No. 61/946,536 that was filed on Feb. 28, 2014, all of which are incorporated herein by reference.

### BACKGROUND OF INVENTION

The field of the present invention is the extraction of resins containing organic compounds from resinous plants, and more particularly to the separation of resin from resin-bearing glandular trichomes being from none or low resin bearing plant matter.

A number of plant varieties produce commercially valuable isoprene derivatives and phenolic compounds such as terpenes, alpha acids, beta acids, flavonoids and terpenoids in cell assemblies know as trichomes or more specifically, in the glands of glandular trichomes. Portions of different plants are rich in trichomes containing compounds of interest in commercial and medicinal applications. Conventional extractive processes may not be adequate in preserving volatile and/or oxidation-sensitive compounds.

Conventional extraction and separation methods utilize solvents which may be polar, non-polar or combinations thereof in order to extract and separate desirable substances. Conventional extraction methods are expensive to conduct safely and may introduce undesired compounds by collateral extraction. Commonly extracted undesirable compounds may include pigments such as anthocyanin, chlorophyll, tannins, saponins and lipids from cellulosic and other plant materials.

Further, as plants mature, many glands of glandular trichomes increase in size, mass and chemical composition. Plant cells associated with the trichomes biosynthesize phenolic compounds including terpenoids such as cannabinoids and humulones. However, at harvest time, when the plant is deemed to have reached a peak in the content of desired compounds, trichome assemblies may be in a range of sizes. It is believed that larger trichomes may have a different composition than the smaller trichomes. Hence, it would also be desirable to separate trichomes by size before chemical extraction or separation of such mixture of compounds from the trichomes.

Trichome and trichome gland assemblies can be separated from the bulk of undesirable plant material by sieving procedures. Larger trichomes can be harder to separate from undesirable plant matter that do not contain desired chemical species

While relatively small trichome glands can be separated from undesirable plant materials by sieving procedures, larger trichomes can be harder to separate, as larger sized sieve fractions contain greater amounts of undesirable plant material thereby diluting the net content of desirable compounds in trichomes and trichome glands. Physical dilution necessitates significant fragmentation of the less desired plant matter. However, as resin bearing trichomes are sticky, physical separation by dry or wet sieving processes are problematic because a large fraction of plant matter fragments of comparable size to the desired trichomes are generated from the mechanical force of agitation, chopping or grinding of the plant matter to release the desirable trichomes and/or trichome glands.

Accordingly, it is an object of the present invention to provide an improved process for separating desirable trichomes and/or specific trichome structures from undesirable trichome parts and/or plant matter that overcomes the aforementioned disadvantages. Such undesirable trichome parts include trichome stems that do not contain desired compounds, or non-resin bearing trichomes.

The above and other objects, effects, features, and advantages of the present invention will become more apparent from the following description of the embodiments thereof taken in conjunction with the accompanying drawings

### SUMMARY OF INVENTION

In the present invention, the first object is achieved by providing a method of brewing beer, the method comprising the steps of brewing a wort containing a source of carbohydrates to extract fermentable sugars, adding yeast to ferment the sugars in the wort, adding a hop extract containing hop trichomes that are substantially free of vegetative matter and extracted material from the vegetative matter.

A second aspect of the invention is characterized by such a method of brewing beer further comprising the step of adding one of dry hops, fresh hop flowers and a hop extract to the wort before, during or after the step of brewing the wort.

Another aspect of the invention is characterized by any such method of brewing beer wherein the step of adding the hop extract containing hop trichomes that are substantially free of vegetative matter and extracted material from the vegetative matter is at least one of before, during or after the step of brewing the wort.

Another aspect of the invention is characterized by any such method of brewing beer wherein the hop extract containing hop trichomes that are substantially free of vegetative matter and extracted material from the vegetative matter comprises water and an alcohol.

Another aspect of the invention is characterized by any such method of brewing beer wherein the alcohol is ethanol.

Another aspect of the invention is characterized by any such method of brewing beer where the hop extract is substantially free of non water soluble lipids.

Another aspect of the invention is characterized by a method making a hop flavored beverage, the method comprising the steps of providing a beverage, and adding a hop extract containing hop trichomes that are substantially free of vegetative matter and extracted material from the vegetative matter.

Another aspect of the invention is characterized by a method making a hop flavored beverage wherein the beverage is non alcoholic.

Another aspect of the invention is characterized by a method making a hop flavored beverage wherein the beverage is vodka.

Another aspect of the invention is characterized by any such method making a hop flavored beverage where the hop extract is substantially free of non water soluble lipids.

Another aspect of the invention is characterized by an alcoholic extract of trichomes that is substantially free of vegetative matter and extracted material from the vegetative matter.

Another aspect of the invention is characterized by such an alcoholic extract of trichomes that is substantially free of non water soluble lipids.

Another aspect of the invention is characterized by such an alcoholic extract of trichomes in which the trichomes are from one of hop cones and flowers.

Another aspect of the invention is characterized by such an alcoholic extract of trichomes in which the trichomes are from one of hop cones and flowers.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a schematic process flow chart.

FIGS. 2A and 2B are schematic diagram of the fluid separation step in FIG. 1.

FIG. 3 is a schematic flow chart of a more preferred embodiment of the process.

FIG. 4 compares in optical micrographs the three indicated size fraction after wet sieve separation and before and after separation in different brine solutions.

FIG. 5 compares in optical micrographs the three indicated size fraction after wet sieve separation and before and after separation in different brine solutions.

### DETAILED DESCRIPTION

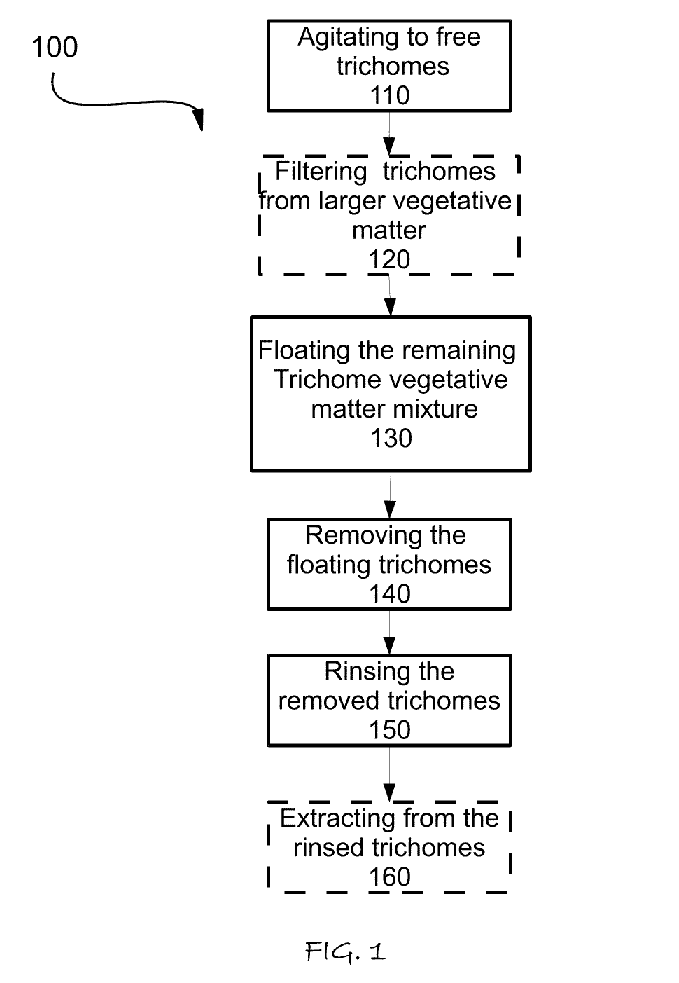

Referring to FIGS. 1-5, wherein like reference numerals refer to like components in the various views, there is illustrated therein a new and improved Method of Plant Resin Separation and Extraction, generally denominated 100 herein.

In accordance with the present invention, process 100 of FIG. 1 comprises a series of steps for separating resin rich glandular trichomes from vegetative matter. Terpenoids including cannabinoids and other compounds secreted within glandular trichomes have significant commercial applications. Glandular trichomes occur most abundantly on the floral calyxes and associated leaves on the inflorescences of female Cannabis plants. The secreted compounds frequently remain in and swell the trichome glands, which are cell clusters, giving them a resinous character.

The particular, sieve sizes, methods of agitation, sieve fractions deployed in one or more separation processes in step 110-130 will depend on the nature of the target glandular trichomes produced by the plant. In step 110, the physical agitation of the plant matter with the desired trichomes is employed so that terpenoid or cannabinoid-rich trichomes and trichome glands break free of the floral calyxes, bracts as well as the leaves they may form on or stick to. Physical agitation of plant matter (110) is preferably done in an ice and water slurry as cold temperatures help increase the efficacy of mechanical forces in breaking free trichomes and resin-containing trichome glands from bulk plant material. Prior to step 110, plant matter may or may not be chopped up or ground in order to help release trichomes and trichome glands from plant matter during step 110.

A preferred method of agitation in step 110 is wet agitation by enclosing the trichome bearing plant matter in a wide mesh sieve bag, which in the case of cannabis is preferably 220 micron. The bag is then agitated in an ice and water bath slurry. As the plant matter is agitated, trichomes of various sizes are released into the ice and water slurry through the holes in the mesh bag or equivalent containment vessel. The trichomes are ultimately removed from the bulk of the plant matter when the water is drained as the bulk vegetative matter is retained in the bag. A commercial washing machine can be used for this purpose with the drain hose line used to collect the trichome and other plant matter that exits the holes in the mesh bag.

Alternatively, the inventive process will also work on dry-sieved material. Such dry sieving of material is preferably performed at cold temperature, as for example like hops which are typically dry sieved at −30 C.

However, wet sieving offers advantages over dry sieving as a considerable amount of undesirable water soluble components will be removed when the water is drained from the final filter fraction(s).

Cold temperatures will have a dramatic effect in either wet or dry method on making the desirable oil glands less sticky and harder. This means that the result is usually higher desirable oil content, with less potential loss of more volatile components. Further, it is also possible to further process dry sieved materials, such as with ice slurry extractions to break oily trichome glands, or the resin bearing portion thereof, away from extraneous matter and remove polar components from plant material (most notably pigments, chlorophyll).

Alternatively, depending on the plant species and the method of separation in the vessel 135, it may be possible to simply place the trichome containing plant matter directly in the brine or fluid and perform the agitation, chopping or grinding in the same vessel 135 as used for separation. Such a method can deploy in the simplest state a hand held kitchen immersion mixer/blender, or the industrial equivalent thereof.

In addition to trichomes and trichome glands of various sizes, significant amounts of undesirable plant matter are released with a mixture of desirable trichomes as this undesirable plant material is frequently of comparable size. Further sieving (optional step 120), can be used to provide one or more cuts or fractions of trichomes and plant matter of different pre-determined size ranges between a lower bound represented by the opening in the next smallest filter, and an upper bound by the previous filter opening size, which is optionally the original mesh bag used in the agitated water bath in step 110.

One such separation method is disclosed in issued U.S. Pat. No. 8,640,877 (Pastorius, Feb. 4, 2014) for a pollen separator, which is incorporated herein by reference. Various raw plant materials are processed via such water and ice agitation method. It further suggests that small diameter mixtures of plant pollen and plant debris are separated by eight sieves, having progressively smaller holes from 220, 190, 160, 120, 90, 73, 45 to 25 microns. However, the patent is silent on separating the desired pollen or other components from plant debris of the same size, other than by solvent extraction. Similarly, U.S. Pat. No. 4,051,771 (Miyata, et al., Oct. 4, 1977), which is also incorporated herein by reference, discloses an apparatus for obtaining lupulin-rich products from hops, in which lupulin glands or trichomes are extracted by a combination of crushing and dry sieving in a frozen state.

Trichomes and trichome glands vary in size as plants mature. It is believed that trichomes of different sizes will have correspondingly different chemical compositions.

In the case of medicinal cannabis preparation, the trichomes in the 74 to 119 micron diameter range are generally considered to be the most desirable for potency,) as the dry weight percentage of desirable substances in this size fraction range is significantly higher than in larger fractions (circa greater than 119 microns). This is likely to be the results of larger particle size fractions, which is with trichomes of 119 microns or greater being diluted by a disproportionate excess of plant matter that is not otherwise separable by mechanical sieve fractionation. In other words, fractions containing trichomes greater in size than about 119 microns would contain a larger proportion of plant matter, resulting in a dry weight lower concentration of the desired medicinal compounds available almost exclusively in the trichome glands.

As it would be desirable to fractionate trichomes based on size, depending on the chemical composition(s) of interest, there is a need for a separation process that does not chemically extract undesirable plant matter and/or chemically modify or oxidize the target terpenoids or terpene derivatives in the separation process. By terpene derivative, I mean terpene compounds and metabolic compounds formed by further synthesis within the glands. Such terpene derivatives include cannabinoids, terpenoids and related resinous compounds.

It has been discovered that sieve filter fractions that contain a higher percentage of undesirable plant matter in relation to desirable trichomes of the same size, can be processed without polar or non-polar solvents that would co-extract undesired chemical compounds from both the undesirable trichome parts (e.g. stalks and disc-cells) and the plant matter of the same size.

Then, in step 130, one of more fractions containing trichomes of a desired size can be further treated to remove unwanted plant matter of the same size. The excess water, that is free draining water or water easily removed by modest pressure, from the sieve fraction is preferably removed, and the remaining solids are disposed on the surface of a tank or vessel 131 containing an inert fluid 135 with a specific gravity greater than that of the net specific gravity of the target trichomes, which is generally but not exclusively greater than about 1.1 gm/cc or greater. The fluid density is more preferably 1.3 or greater

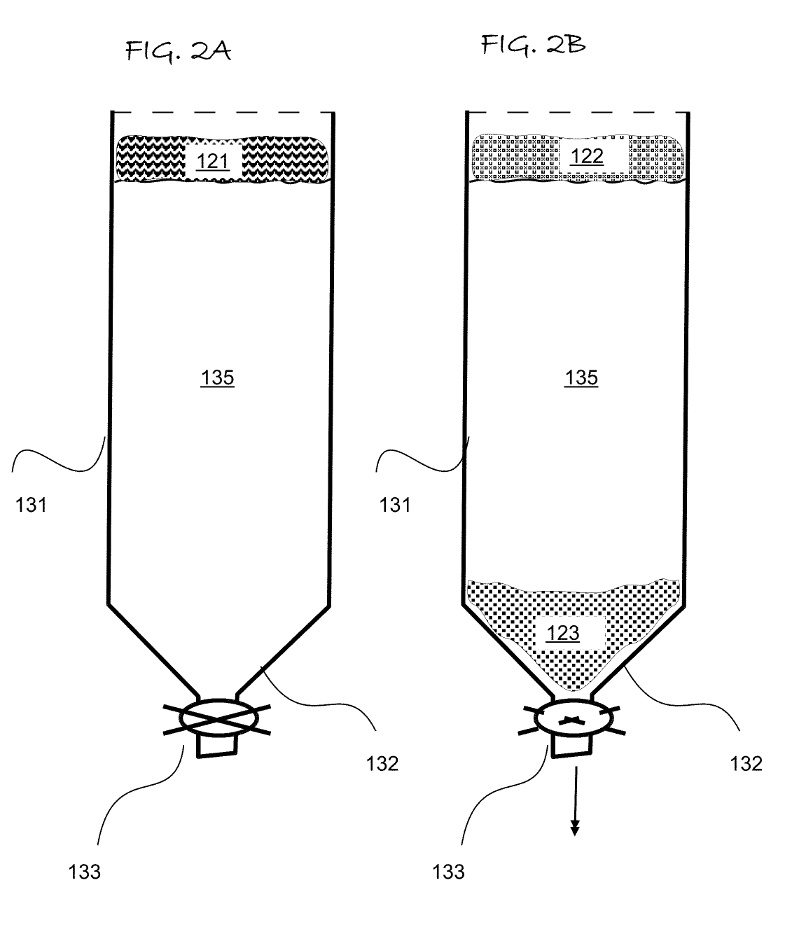

As shown in FIG. 2A, after sufficient agitation to wet or introduce all of the mass 121 to the fluid 135, the heavier typically more cellulosic fractions including vegetative matter, disc cells, broken and visibly oxidized trichome glands and non-gland portions of trichomes (stalks) sink 123, separating at the bottom portion 132 of vessel 131. The lighter fraction 122, containing resin filled trichomes float on fluid 135 (FIG. 2B).

Accordingly, a preferred embodiment of the invention disclosed herein is the separation of cannabis trichomes from cannabis vegetative matter in the size range of 160 microns and greater, and more preferably 90 microns and greater. However, the inventive method will remove undesirable plant components from small size fractions as well. It should be noted that below 160 microns, the main contaminant in cannabis is actually the trichome stalks and other non-glandular trichome parts. Unexpectedly, I also observed visibly broken and oxidized glands only in the sinking fraction 123 as described below with respect to step 130, while the floating fraction 122 contained only full, bulbous clear trichome heads.

Depending on the plant variety and the ease of trichome release without fragmentation, it may be desirable to avoid chopping, grinding and fragmentation until the weakly bound trichomes are released by minimum physical agitation, such as by shaking and agitating without chopping or grinding. For example, the initial shaking may deploy a sieve with 220 micron holes.

Further, prior to step 130, post-sieved material may undergo further physical separation by agitation in fluid slurry may contain solid matter such as ice, ceramic beads, and the like, as well as chemical agents, such as wetting agents, dispersion agents, ionic and/or non-ionic surfactants, saponification (soaping) agents, anti-foaming agents and the like.

The separating medium 135 is a dense inert fluid that is easily removed from the desired lower density trichomes, and also preferably has a low solubility of oxygen, or oxygen is readily removed by sparging with inert gases such as carbon dioxide, nitrogen and argon to prevent oxidation.

The inert fluid is more preferably a brine that can be formed by the super saturation of water with a soluble salt, such as sodium chloride, magnesium chloride or magnesium sulphate, and the like. For example, hot water can dissolve about 350 gm/L of common salt (sodium chloride), of which upon cooling some will precipitate, leaving dense salt saturated brine with a specific gravity greater than about 1.18 gm/cc. The separating fluid 135 may include ionic and non-ionic surfactants or any other such agent that facilitates the dispersion of desired glandular trichomes in the floating fraction 122 from undesirable components that form the sinking fraction 123.

It is also preferable to deploy moderate agitation to optimize dispersion of the plant matter-trichome mixture 121 as to facilitate the physical separation of the plant matter 123 which sink and the trichome-rich layer 122 which float. Agitation may be achieved by one of or any combination of reciprocal plunging, shaking, stirring, re-circulating water jets. Agitation may also be achieved via acoustic energy via submerged ultrasonic probes or loudspeaker outside of the vessel. Sound vibrations of a particle frequency range may be operative provide controlled and measurable mechanical separation energy into the fluid trichome/brine solution. This energy will be used to help further disperse all particles so that they may separate based on density while minimizing flocculation, clumping, Van der Wals forces, etc. Agitation can also be achieved by jets of compressed gas, such as air or more preferably nitrogen or inert gas.

It is preferred to use cold brine as fluid 135, and more preferably dry ice chilled brine so the resin filled trichomes and the more volatile isoprene or terpenoid compounds are precluded from evaporation and oxidation in the carbon dioxide (CO₂) saturated environment.

The lower portion of vessel 131 is preferably shaped as an inverted cone, so that the vegetative fraction 123 can be drained as shown by the arrow in FIG. 2B, by opening the valve 133. Alternatively, or in addition to, the trichomes floating on the top of the fluid 135 in the vessel 131 can be removed (step 140) from the vessel by a fine screen or mesh into the fluid to lift them from underneath, and/or draining the plant matter from the bottom of the vessel either before or after using the screen.

Maintaining cold temperatures in fluid 135 will have a dramatic effect on reducing the cohesive nature of the often sticky desirable oil-containing glands from less desirable material in mixture 121. By reducing cohesion in mixture 121, the efficiency of the separation of trichome rich floating 122 from the undesirable sinking fraction 123 is facilitated. An optimized dispersion of mixture 121 is believed to yield a floating fraction 122 having a higher desirable oil content. Maintaining cold temperatures may also reduce the chemical degradation as well as evaporative loss of certain and/or more volatile desirable components. Further, it is also possible to further process mixture 121 obtained from dry sieving, such as with ice slurry extractions to break oily trichome glands, or the resin bearing portion thereof, away from extraneous matter and remove polar components from plant material (most notably pigments, chlorophyll) otherwise removed in 100.

After physical separation of the floating desired trichomes, the trichomes may be further washed to remove the salt from the brine (step 140), after which the resulting product is then rinsed preferably with water, particularly when the liquid 135 is a salt brine or another non-solvent, to remove this liquid 135 (step 150).

Depending on the amount of undesirable plant material in any sieve fraction, or bulk mass or material introduced to the fluid 135 in vessel 130, it is preferable to repeat the floating in step 130 multiple times after draining off the sinking vegetative fraction 123 via valve 133.

During such repetitive floating in step 130, as the brine or fluid 135 is replaced, the specific gravity thereof may be adjusted in order to optimize the separation of the desired glandular trichome components from the undesirable components from different sieve fractions or the previous draining step. It is believed that desirable and undesirable components from each of the sieve fractions may have correspondingly unique components with unique properties. Such modification to the fluid in step 130 may include one or more of adjustments, to the composition, i.e. type of salt, concentration of salt to vary the specific gravity, as well as the temperature, which will also affect the specific gravity.

The trichomes can be further processed (optional step 160) to remove or extract the desired chemical compounds from the cell walls and nuclei, with any known or subsequently discovered solvent and/or process methods. Alternatively, the lighter fraction 122 (containing resin filled trichomes float on fluid 135) may be treated with a flocculating agent to aid in recovery of the trichomes. The inventive process may be useful for the purpose of separating non-oil containing products (e.g. the trichome stalk), which are expected to float in the vessel 130 between the floating lighter fraction 122 and sinking fractions 123. These components may prove to have additional uses such as a replacement for DE (diatomaceous earth).

In particular, the invention is applicable to all plants from families with glandular trichomes, for example Asteraceae (sunflower, etc.), Solanaceae (tomato, tobacco, potato, pepper, eggplant, etc.), Cannabaceae (Cannabis sativa, Humulus, H. lupulus) and Lamiaceae (mint, basil, lavender, thyme, etc.). In a non-limiting manner, the invention can apply to trichomes of plants from the following genera: Populus, Nicotiana, Cannabis, Pharbitis, Apteria, Psychotria, Mercurialis, Chrysanthemum, Polypodium, Pelargonium, Mimulus, Matricaria, Monarda, Solanum, Achillea, Valeriana, Ocimum, Medicago, Aesculus, Plumbago, Pityrogramma, Phacelia, Avicennia, Tamarix, Frankenia, Limonium, Foeniculum, Thymus, Salvia, Kadsura, Beyeria, Humulus, Mentha, Artemisia, Nepta, Geraea, Geraniaceae, Pogostemon, Majorana, Cleome, Cnicus, Parthenium, Ricinocarpos, Hymennaea, Larrea, Primula, Phacelia, Dryopteris, Plectranthus, Cypripedium, Petunia, Datura, Mucuna, Ricinus, Hypericum, Myoporum, Acacia, Diplopeltis, Dodonaea, Halgania, Cyanostegia, Prostanthera, Anthocercis, Olearia, Viscaria.

Preferably, the plant is a plant from the Cannabaceae or Lamiaceae family. In a more preferred embodiment, the plant belongs to the genera Humulus or Cannabis, both members of the Cannabaceae family. The hop plant, Humulus lupulus, produces glandular trichomes containing humulone and lupulone which are important in beer brewing both from organoleptic and microbial-stability impact. Cannabis produces pharmaco-active and non-pharmaco active compounds. Compounds biosynthesized in the glandular trichomes of hops have anti-bacterial properties and recently have been investigated in the development of drugs used to treat diabetes. Compounds biosynthesized in the glandular trichomes of Cannabis may have anti-epileptic, anti-emetic, anti-inflammatory, neuroprotective and even anti-cancer properties.

The inventive process is also applicable to trichomes from one genetically distinct organism being grown on another, a genetically modified organism, (GMO). An example of this would be transgenic algae (or fungi such as Aspergillus) engineered to produce oil trichomes and associated oils from Cannabis. Hence, the invention is also applicable to extracting cannabinoids, terpenoids, and related terpene derivative compounds from plants, fungi or algae of any species, including transgenic organisms that express one or more nucleic acid encoding a protein associated with the metabolic pathway to synthesize such compounds.

This process could be employed in a manner similar to the production of ascorbic acid (vitamin c) in a continuous-flow or batch production schematic. In this case, the fungus Aspergillus niger is genetically engineered to produce vitamin C.

It should also be appreciated that trichomes, glandular or otherwise, are frequently involved in allelopathy. This invention may allow for the production of new botanically sourced pesticide compounds, previously cost-prohibitive, to research and/or produce. One such example is the separation of nicotine containing trichome from tobacco leaves, which is used as a very potent insecticide, as well as insecticidal agents in trichomes on tomato leaves and stalks.

Density based isolation of the trichome cells has been limited to laboratory scale extraction for research purposes that are unsuitable for commercial production. Such density extraction methods use the Percoll™ reagent to form density gradients in test tubes when subjected to very high centrifugal forces from a centrifuge apparatus. This technique creates a gradient with the Percoll reagent, within which fine layered bands of different density materials will separate.

Such methods are not suitable for production purposes for several reasons. First, the Percoll suspension introduces contamination in the form of silica nanospheres and the repellant coating. This material cannot be removed after separation due to the nano size. Percoll reagent, in addition to being a contaminant is an expensive material. Hence, It is only suitable for research purposes in extracting small quantities of cell or organelles, usually by forming a density gradient by centrifuging. Though density gradients can be formed by layering methods, the introduction of any reasonable quantity of macerated plant matter will require mixing that will disturb such a gradient

Prior art wet sieving extraction processes for Cannabaceae trichomes yield an inseparable mix of desirable trichomes and undesirable plant debris, based on size as well as the duration and intensity of agitation. Such a process is generally disclosed in the International Patent Application with publication no. WO 2014/00919A2 (to J. P. Love, which published (January 2014), and is incorporated herein by reference. Smaller size fractions of plant material tend to yield a greater amount of desirable trichomes and therefore a higher yield of desired substances. However, the greater the amount of agitation of plant material, the greater the concomitant release of both desirable and undesirable substances from plant material regardless of particle size restrictions.

Hence, such a prior art water extraction processes has 2 primary limitations. First the total yield of trichome resin is limited to the smaller trichomes. While the extraction of resins from other trichome bearing plant matter can be accomplished with solvents, these processes are less desirable as mentioned in the background section. As the total yield of desirable substances from this remaining plant matter will be low, they are even less economically attractive than using only solvent extraction.

The second limitation is the total concentration of cannabinoids resins. The state of the art water extraction processes result in up to about 60-70% THC and related resins, which is comparable to solvent extraction. State of the art water extractions yielding material with 60-70% by weight total cannabinoid resins, including THC. Such water extraction products utilize a significantly smaller portion of the total THC bearing trichomes as these extracts are limited, at best, to particle sizes of 90 to 45 microns. Although, occasionally some strains of cannabis yield material that qualifies as “ice wax” from the 120 micron fraction.

In a currently preferred embodiment, the total yield of cannabinoids resins, based on weight of starting plant matter, is higher than current water extraction methods by a factor of about 2× (usually 3 to 6% of the total plant matter), with the resulting product being purer, containing 70-75% by weight total cannabinoid resins.

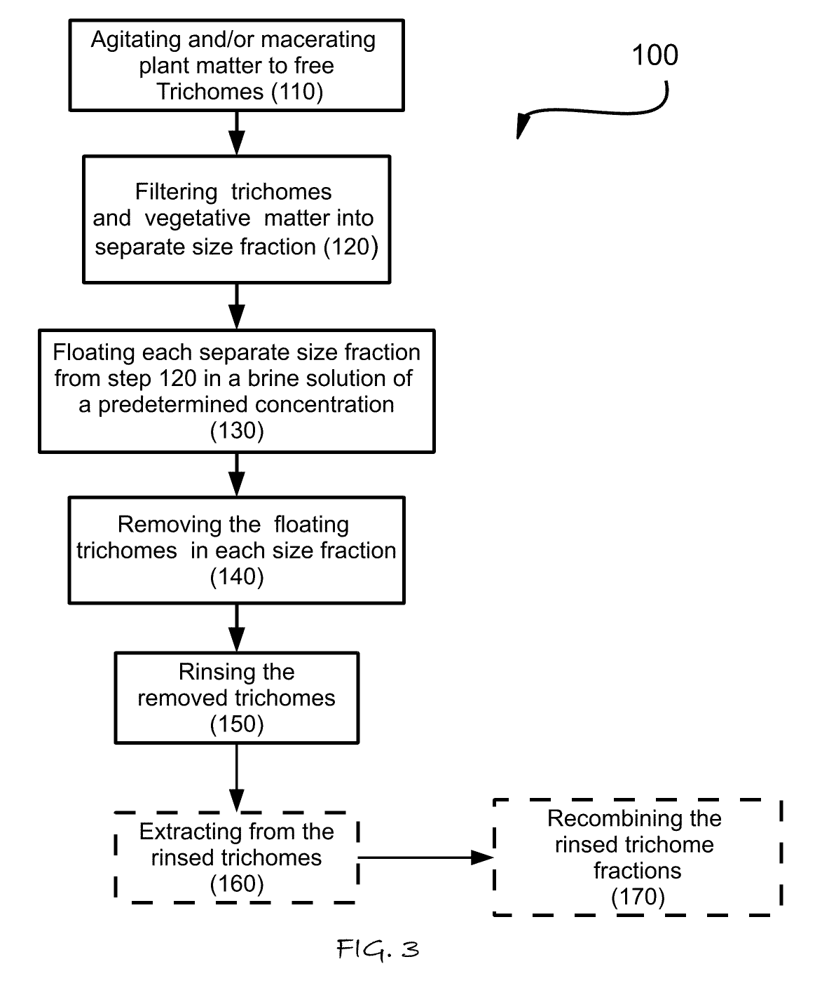

It has been discovered that such higher yields and greater extraction efficiency can be achieved by a totally different approach. Rather than gentle agitation of plant matter to sever the more trichomes with respect to undesirable plant debris, a greater variety of plant material is aggressively macerated to release all size trichomes as well as an abundance of undesirable plant debris. While this produces undesirable plant debris of all sizes, including trichome head or resin sacks, it has been discovered that the gravity separation process, in a uniform density fluid, is best optimized for each size fraction, which is floated in a different vessel from the other size fractions. More preferably, each size fraction is separated in a different density fluid, which is preferably a brine or salt solution. Each fraction is obtained by draining the cold agitated slurry of plant matter and ice water through a 220 micron opening mesh bag into a vibratory screen stack with constant cold water flushing. The preferred screen sizes, indicated by the size range of the retained fractions, is provided in Table 1. Each sieve size fraction is then floated in a separate brine bath (FIG. 3), as the smaller fractions take longer for complete gravity separation, in that once the fraction is covered in the brine, the smaller desirable resin heads take longer to float free of the undesirable heavier matter. Alternatively, if the sieve fraction is washed into the top of a tank of brine, it takes longer for the undesirable matter to sink. It is also preferable that the brine salt is a magnesium sulfate brine, and most preferable that it contains about 10 wt % sodium chloride as a deflocculating agent in the density separation process after sieving. The use of sodium chloride alone is problematic in that it is difficult to rinse the residual salt, which negatively effects the taste and flavor profile of the product. In contrast, the preferred brine composition can be readily rinsed in a final step without leaving detectable residue. The use of 10% sodium chloride aids in deflocculating of agglomerated matter, so the denser undesirable matter separates from lighter matter and sinks.

As the undesirable stalks and desirable resin heads in the smaller size fractions segregate in the floating step significantly slower than in the larger size fractions, it is also desirable to use a greater density fluid or brine for these smaller fractions, as disclosed in Table 3. Further, by separately treating the more slowly segregating components of smaller sizes the tanks sizes and or tank number for the floating step can be adjusted to accommodate the different separation rates. In other words, tanks used for the heavier fractions will be cycled faster, so the larger or more numerous tanks for the smaller fractions can provide a comparable process throughput. Using a more dense brine for the smaller fractions with the most desired salt composition accelerates the gravity separation process.

The preferred brine compositions also enhances the separation of trichome fragments, namely the undesirable stalk and disc cells from the resin bearing sacks at the end of the disk cells. Unless the trichomes are extremely mature, the stalks due to their length, can be a significant fraction of the total trichome volume. Additional dilution of desirable substances results from the introduction of non-glandular trichomes known as cystolith hairs. Cystolith hairs are composed mainly of silicon dioxide (SiO₂) and frequently contain calcium carbonate (CaCO₃) crystals within.

The currently preferred concentrations of brine for each sieve fraction as listed in Table 1:

TABLE 1

| | | | Control | | |
|---|---|---|---|---|---|
| | | | (gm from | | |
| | | | 1 Kg. | Separated | |
| Sieve size | | | plant | (gm), after | Fraction |
| (microns) | | | matter, | gravity | recovery, |
| (particles | | | dried, | separation | % with |
| this size | Brine | Brine salt | without | in | respect |
| and | density | composition, | gravity | indicated | to |
| larger) | (gm/cc) | (by wt %) | separation) | brine | Control |
| 125-220 | 1.11 | 90/10% | 4.45 | 2.36 | 53% |
| | | SO4/NaCl | | | |
| 105-124 | 1.12 | 90/10% | 5.25 | 3.21 | 61% |
| | | MgSO4/ | | | |
| | | NaCl | | | |
| 90-104 | 1.13 | 90/10% | 6.97 | 6.15 | 88% |
| | | MgSO4/ | | | |
| | | NaCl | | | |
| 70-89 | 1.14 | 90/10% | 16.84 | 14.03 | 83% |
| | | MgSO4/ | | | |
| | | NaCl | | | |
| 50-69 | 1.15 | 90/10% | 16.71 | 7.26 | 43% |
| | | MgSO4/ | | | |
| | | NaCl | | | |
| 40-49 | 1.15 | 90/10% | 2.5 | 1.09 | 44% |
| | | MgSO4/ | | | |
| | | NaCl | | | |

| | | | | | |
|---|---|---|---|---|---|
| Total recovery | 52.7 | gm | 34.1 | gm | 0.65% |

The results in Table 1 were obtaining starting with 1,000 gm of plant matter from the Cannabis plant O.G. Kush variety “Tahoe” (usually referred to as “Tahoe O.G”.). Hence, the total yield of resin heads without other matter was 3.4%. Other varieties have yielded as high as 6% with about 74.5% total cannabinoids by weight.

This improved process is illustrated in FIG. 3 in which in step 130, each sieve fraction is separately floated. In step 170, the trichomes from each fraction are optionally recombined at the end. The optional solvent separation step, 160, can be performed before or after the recombination. To the extent plants can be bred to create different chemical species in different size trichomes, it may be desirable to perform the solvent extraction from each trichome size fraction separately. As the trichome fraction are largely free of vegetative matter, the undesired components (lipids/waxes, pigments) of associated plant material will not be co-extracted.

It is important to use a brine that does not contain or introduce solid particle of any type, other than agents that can generally be washed or removed in subsequent processing, that is the brine should consist essentially of water and a salt or salt mixture, which can include other water soluble compounds and additive. Brine salts are the primary components responsible for the greater density than water, and as such constitute the essential character of this aspect of the invention.

After the desired fractions that float are removed from the sinking fractions, they are rinsed to remove brine. The rinse water is easily purified by reverse osmosis, which generates more brine for reuse in the process, after appropriate modifications of concentration to achieve the preferred density.

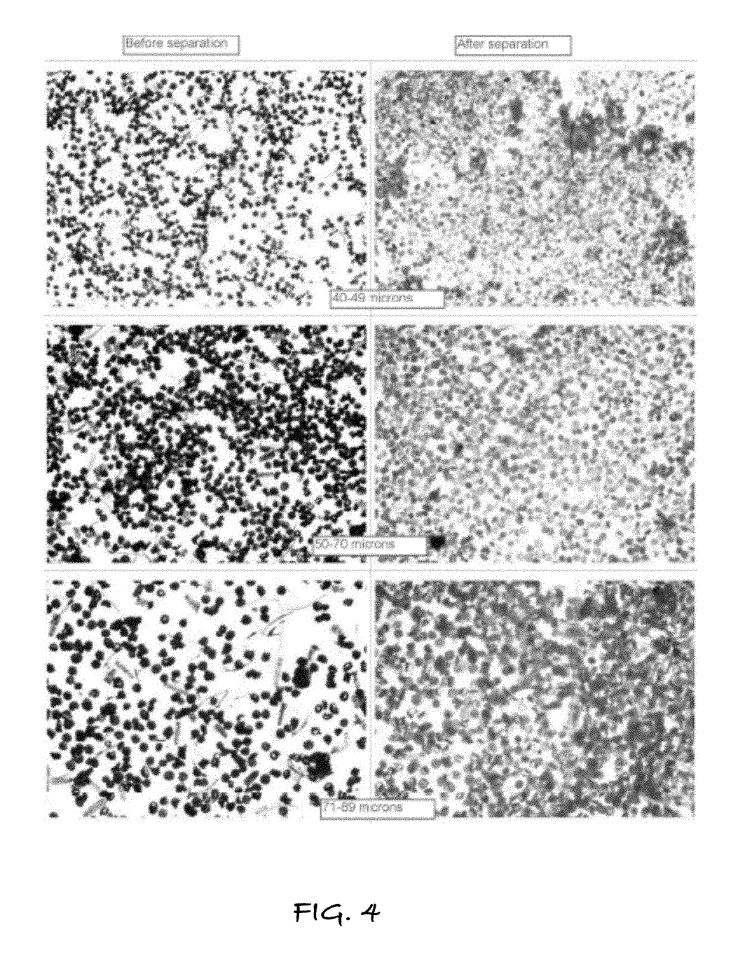

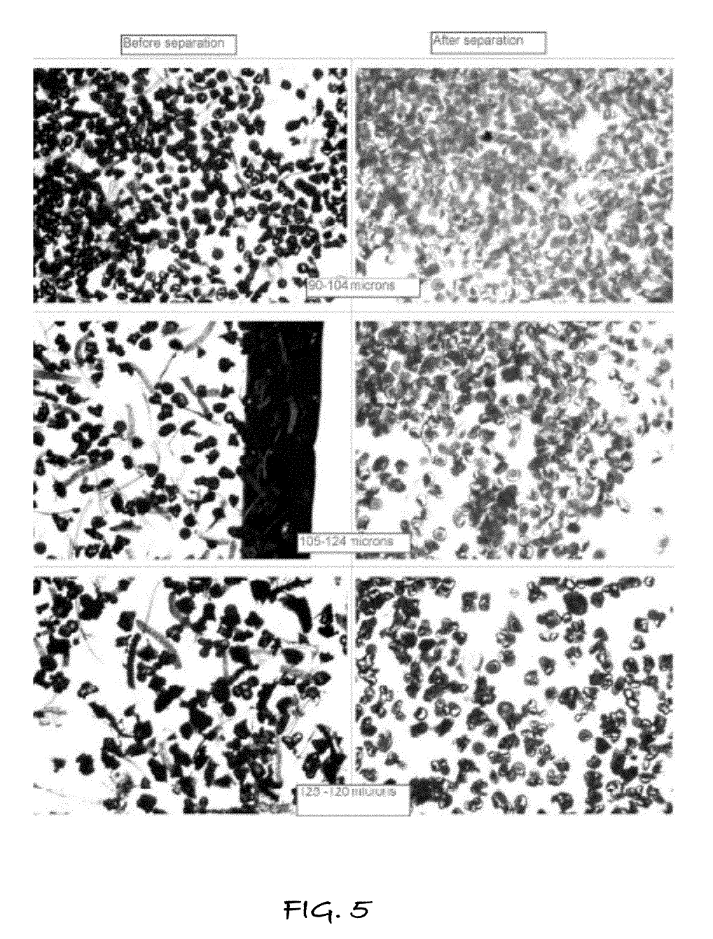

It has been discovered that as the preferred process results in a resin product that is more pure, as it has a lower ratio of stalks, cystolith hairs and other undesirable plant debris to trichome resin heads, as shown in the micrographs in FIGS. 4 and 5. While each sieve fraction in the left column in these Figures contains stalks, plant debris and globular resin heads, the right column show the floating matter that has been collected according to the conditions of Table 1 is full, bulbous clear trichome heads that are essentially free of stalks, cystolith hairs and other undesirable plant debris.

As the trichome fractions once separated as shown in FIGS. 4 and 5 in the right hand column are essentially resin heads free of stalks, cystolith hairs and other undesirable plant debris, the can be recombined to yield a final resin product of about 3.4 grams, with between about 70-75 weight percent total active cannabinoids, based on prior experimental results been measured by high performance liquid chromatography.

All of the above methods described generally and more specifically with respect to Cannabaceae trichomes, are also applicable to separating and/or purifying trichomes from the other plant species, with appropriate adjustment in the fluid 135 to account for the density variation of the trichomes and other objective of the separation process. The density of the trichomes will depend largely on the plants species, which have different biochemical processes during plant growth, and can also vary with the growth stage and maturity of the plant. For example, in the case of the trichomes from the hop plant they contain varying percentages of alpha acids or humulones, beta acids or lupulones, essential oils (such as the terpene hydrocarbons myrcene, humulene and caryophyllene, among many other), and flavonoids, primarily xanthohumol, as well as 8-prenylnaringenin and isoxanthohumol. As many of these compounds have long chains of olefin hydrocarbons that like other lipids are not soluble in water, the density of the trichomes can be significantly lower than those of other plants species. Hence, it may be preferable to float or suspend such glandular trichomes, depending on the plant species, on the brine or fluid 135 having a higher density than the trichome, which in the case of hops trichomes, among others, is preferably greater than about 1.08 gm/cc, more preferably greater than about 1.05 gm/cc and most preferably greater than about 1.01 gm/cc.

Further, while it is preferable that the fluid be a brine salt, other fluids can be used if it is desirable to avoid extraction of water soluble trichome components in the aqueous brine, such as organic compounds, and more preferably continuous phase organic compounds without suspended matter. Moreover, as the essential objective is to separate the trichome from other plant matter, so long as the plant matter, and particularly any macerated plant matter, sinks in the fluid faster than the trichome, the sinking plant matter can be removed before the released trichomes have floated to the top of the fluid 135. This particularly is the case when the released trichomes float relatively slowly due to a small size, and the larger plant matter sinks faster.

Further, depending on the nature of the fluid 135, the residue after the trichomes are removed may be de-minimus or inconsequential with respect to the intended purpose of the resulting product, and further rinsing of fluid and/or drying may not be necessary or may essentially occur as a result of further purification of separation of chemical compounds in the trichomes, or reactions, such as forming chemical derivatives of compounds in the trichomes to create novel compounds as flavoring agents, medicines, insecticides, insect attractants, insect repellants and like.

It has been discovered that trichomes extracted from hop and hops flower by the novel process have several advantages over traditional brewing practices for making beer.

While beer can be brewed with fresh hops using the hop flowers, the fresh hop flowers are only in suitable condition as a flavoring components while still fresh and un-oxidized for only about 6 hours. Accordingly, once hops are harvested they are processed to be suitable for storage and for year round use in brewing, by either kiln drying the hop cones for use as is, or compressing the dried hop cones into dry pellets. Alternatively, resins and oil can be extracted from the hop cones and then stored. As such extraction generally involves solvents, the solvents may remove other undesirable compounds from the vegetative or leafy matter in the hop flowers.

The dry hop flowers, hop pellets and hop extract (hop components) can be mixed with any of the beer components before or after brewing. Beer brewing involves extracting fermentable sugar by the reaction of enzymes with carbohydrates from grains and seeds, such as wheat, barley, rice and corn. The reaction occurs in heated water to accelerate the brewing reaction to form a wort. The wort contains sugars that are fermentable by beer yeasts. The fresh or dry hop flowers, hop pellets and hop extract can be adding before or while the wort is brewed, which is known as boil hopping. Or the hop components can mixed with the wort after the extraction of fermentation sugars, such as just before or during fermentation of the sugars to alcohol, as well as after the beer is fermented. Adding hop components after boiling the wort or after fermentation in the finished beer is referred to as dry hopping. Dry hopping may be preferable to prevent volatile hop aromas from evaporating and dissipating. However, during the boiling of the wort with hops (boil hopping) alpha acids from the hops are converted by isomerization reaction to iso-alpha acids, which are the bittering components. The degree of conversion is effect by the boiling time, as well as the quantity of alpha acids in the hop variety. Hops also contain Beta acids, which may result in undesirable “harsh” bitterness.

Beers with high hop content have gained tremendous popularity, such as India Pale Ale (IPA), but especially a double hopped IPA, and particularly a triple hopped IPA that is made seasonally by the Russian River Brewing Company in Santa Rosa, Calif.

Many craft brewers use some combination of boil and dry hopping, depending on the hop varieties. Using a large quantity of hops presents two issues in such beers. First, in addition to the flavor and bitterness from the alpha and beta acids, as well as the flavor compounds in the hop trichomes, the beer picks up flavor from the leafy or vegetative matter of the hops flowers.

Confirming the research of others, we determined that many consumers find the later flavors to undesirable, in comparison with beers produced by using the novel trichome extracts from hops, in which vegetative matter has been eliminated by separation from the hops trichomes. Further, to the extent it is desired to minimize the bitterness level from hops, but still retain other desirable flavors from the hop trichomes, boil hopping is optionally eliminated or reduced.

The use of the novel trichome extract to flavor beer has an economic advantage for brewers as well, particularly if the brewer is trying to provide a very high and pronounced hop flavor, such as in IPA's and any similarly produced beers.

It has been recognized that using a large quantity of solid hop products, in particular hop pellets and whole-cone hops, for example, is disadvantageous at whatever stage they are added to wort or beer, since after extraction of the flavoring ingredients the spent hops or hop particles, being undesirable in finished beer need to be removed by decanting. As the high percentage of the vegetative matter in the spent hops have insoluble cellulosic components that are hydrophilic they absorb and retain a large volume of the beer produced. The removal of spent hops frequently results in a loss of 15% of the finished beer. Further, the removal of large quantities of spent hops presents requires special equipment and higher levels of maintenance.

Although other forms of hop extracts are known, they are generally solvent extracted, which can also remove some undesirable components from the vegetative matter which then carry over into the beer flavor. Even screening and sifting processes can still carry over small but significant fragments of plant vegetative matter. As plant vegetative matter that has been macerated into smaller particles can leach more undesirable flavors than a larger quantity of solid plant matter might in say boil or dry hopping, it is desirable to isolate trichomes free of such plant vegetative matter.

In contrast, the inventive process provides a pure form of trichomes that have been physically separated from the hop cones and flower, being substantially free of plant vegetative matter. As such, when the pure form of trichomes are added to wort or beer, they do not leach undesirable flavor components, and can be used in a boil hopping process to produce bitter flavors by forming iso alpha acids. As plant matter does not contact the wort or beer, unless desired, the flavors from the plant matter do not carry over to the fermented beer, and no volume of beer is lost when the plant matter is separated from the beer. In such methods, the trichome isolates can be added directly to the wort during boiling, or can be suspended in the wort, being contained in a mesh bag or filter before or after wort boiling, as well as during and after fermentation to emulate dry hopping processes.

Further, different varieties of hops may contain water insoluble oils, which are primarily lipids. These oils may still leach out and positively or adversely flavor beer or other beverage.

Concentrates of trichomes can be provided that optionally remove the water insoluble oils. The trichome solids obtained by the inventive processes may dissolved in a food grade alcohol, which is preferably 90-95% by volume ethanol, but optionally glycerin, and any other alcohol mixture, including fusel oils, so long as the alcohol is generally recognized as safe (GRAS) by the FDA. While the highly water insoluble oils or lipids component of the trichomes may form a separate liquid phase, which may or may not contain some alcohol, they can be removed by physical separation of the discrete layers. If a discrete oil layer does not form, these water insoluble oils or lipids component can be removed by reducing the temperature to well below zero degrees centigrade to cause a solid separable gel to form. The gel is removed by physical separation, and the alcohol soluble components are drained from the gel. The trichome components that remain soluble in the alcohol can be added from this drained concentrate, or the concentrate can be diluted with water or water-alcohol mixtures.

Further, because the novel trichome extract from hops can be dissolved and provided as a concentrate in alcohol or alcohol-water mixtures, it can be used before, during or after the brewing process to adjust the hop taste and profile. The hop flavor profile can be adjusted after brewing by adding different combinations of hop concentration from different hop strains and growing regions.

Such concentrated forms of hop trichome extracts, which optionally do not include water insoluble lipid components, allows beverage developers to experiment and find new and interesting flavor profiles in beer and other beverages by starting with a base beverage, like a non-alcoholic malt beverage, beer, ale or porter, and develop different combination in small batches for consumer taste testing. As the vegetative matter, such as leaves, associated with hop flowers can be eliminated in the process of separating the trichomes from the hop flower, the taste profile of the resulting beverage is different than that formed using other hop concentrates. The concentrate can also be boiled in additional water to form some level of iso alpha acids to add bitter notes to the flavor profile.

The same approach can be use with other alcoholic beverages, such as whiskey, scotch, gin, rye, brandy or vodka. This method can also be used with other non-alcoholic beverages, such as flavored sodas and energy drinks, as well as to formulate new mixed drinks that have an alcohol content intermediate between beer, wine and ale and distilled spirits, that is from about 15 to about 40 volume percent.

Hence, another aspect of the invention is a method of brewing beer that deploys any conventional form of hops flowers, such as fresh or compressed pellets being added to the wort, and then boiling or brewing the wort to form bittering iso alpha acids. However, after removing the vegetative components of the hop flowers by decanting or racking, the hop flavor of the beer can be increased by adding the hop trichomes isolated by the inventive process, either in the solid form or from a concentrated solution containing some alcohol. The conventional form of hop flowers might be the normal amount say for a standard IPA, which would remove well less than 5-10% of the finished beer. The step of adding trichomes or a concentrate of the trichomes dissolved in an alcohol-water mixture can then be carried out to the extent the desired flavor profile is reached, without further loss of finished beer. It should be appreciated that the hop flavors can also be added to the initial wort by using the isolated hop trichomes or a concentrate of the trichomes dissolved in an alcohol-water mixture. As the alpha acids compounds in hops have some anti-microbial properties, they also aid in preventing spoilage organisms from proliferating in the brewing process.

Another aspect of the invention is the preparation of a beverage and then adding trichomes or a concentrate of the trichomes dissolved in an alcohol water mixture until the desired flavor profile is reached. A more preferred aspect of this process is when the beverage is a distilled spirit, such as whiskey, scotch, gin, rye, bourbon, rum, brandy or vodka. It has been discovered that the trichome concentrates add very desirable flavor profiles to vodka, which are not masked by other components, such as the flavor components extracted during the barrel aging of whiskey, scotch, rye, bourbon, rum and brandy.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

I claim:

1. A method of brewing beer, the method comprising the steps of
a. brewing a wort containing a source of carbohydrates to extract fermentable sugars,
b. adding yeast to ferment the sugars in the wort,
c. adding a hop extract containing hop trichomes that are substantially free of vegetative matter and extracted material from the vegetative matter.

2. A method of brewing beer according to claim 1 further comprising the step of adding one of dry hops, fresh hop flowers and a hop extract to the wort before, during or after the step of brewing the wort.

3. A method of brewing beer according to claim 1 wherein the step of adding the hop extract containing hop trichomes that are substantially free of vegetative matter and extracted material from the vegetative matter is at least one of before, during or after the step of brewing the wort.

4. A method of brewing beer according to claim 1 wherein the hop extract containing hop trichomes that are substantially free of vegetative matter and extracted material from the vegetative matter comprises water and an alcohol.

5. A method of brewing beer according to claim 4 wherein the alcohol is ethanol.

6. A method of brewing beer according to claim 4 where the hop extract is substantially free of non water soluble lipids.

7. A method making a hop flavored beverage, the method comprising the steps of:
a. providing a beverage, and
b. adding a hop extract containing hop trichomes that are substantially free of vegetative matter and extracted material from the vegetative matter.

8. The method making a hop flavored beverage according to claim 7 wherein the beverage is non alcoholic.

9. The method making a hop flavored beverage according to claim 7 wherein the beverage is vodka.

10. The method making a hop flavored beverage according to claim 7 where the hop extract is substantially free of non water soluble lipids.

11. An alcoholic extract of trichomes that is substantially free of vegetative matter and extracted material from the vegetative matter.

12. An alcoholic extract of trichomes according to claim 11 that is substantially free of non water soluble lipids.

13. An alcoholic extract of trichomes according to claim 11 in which the trichomes are from one of hop cones and flowers.

13. An alcoholic extract of trichomes according to claim 12 in which the trichomes are from one of hop cones and flowers.
